(19) United States
(12) Patent Application Publication
(10) Pub. No.: US 2003/0146764 A1
(43) Pub. Date: Aug. 7, 2003

(54) Protector for blade module of information processing apparatus

(76) Inventor: Chun-Liang Lee, Taipei (TW)

Correspondence Address: BIRCH STEWART KOLASCH & BIRCH, PO BOX 747, FALLS CHURCH, VA, 22040-0747, US

(21) Appl. No.: 10/066,370

(22) Filed: Feb. 5, 2002

(51) Int. Cl. H01H 31/04

(52) U.S. Cl. 324/538

(57) ABSTRACT

A protecting system for protecting a blade module of an information-processing apparatus includes a detecting unit, a starting unit and a triggering unit. The detecting unit determines whether or not the connection between the blade module and the information processing apparatus is good. When the connection is good, the starting unit starts the triggering unit so that a working voltage is safely provided to the main circuit of the blade module.

### BACKGROUND OF THE INVENTION

1. Field of the Invention

The invention generally relates to a protecting system, and more particularly relates to a system for protecting a blade module of an information-processing apparatus, such as a computer, when the blade module is not well connected to the information-processing apparatus.

2. Related Art

Together with the technological developments of information processing electronic apparatus for helping people managing information are increasingly being put into use. People rely on information processing apparatus, such as computers, to improve the efficiency of working and research, whether for personal use, for enterprises or for government departments.

As the demand for information processing apparatus increases, the functions of these apparatus are also increased to meet users' requirements of information processing. The increased functions are usually adapted to the information processing apparatus through blade modules or so-called interface cards. In a server system, blade modules are commonly applied.

However, there is a drawback of the connection of blade modules. Since the blade module is manually connected to the information-processing apparatus, it is prone to being connected incompletely. Then the blade module or the information-processing apparatus is damaged when electrical power is applied. Another drawback is that there is generally a DC to DC voltage transformer required for a conventional blade module. The circuit of the DC to DC transformer is rather complicated and costs a lot.

Therefore, a blade module that can prevent itself from being damaged when it is not well mounted, and has a simpler and lower cost power circuit is needed for solving the aforesaid problems.

### SUMMARY OF THE INVENTION

The object of the invention is therefore to provide a system for protecting the blade module of an information-processing apparatus when the module is not well connected to the information-processing apparatus.

To achieve the aforesaid object, a protecting system for the blade module of an information-processing apparatus according to the invention includes a detecting unit, a starting unit and a triggering unit. The detecting unit determines whether or not the connection between the blade module and the information-processing apparatus is good. When the connection is good, the starting unit starts the triggering unit so that the working voltage can be provided to the main circuit of the blade module.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a constructional diagram of a protecting system for a blade module of an information-processing apparatus according to the invention;

FIG. 2 is a systematic block diagram of a protecting system according to the invention;

FIG. 3 is a block diagram of a detecting unit in an embodiment of the invention;

FIG. 4 is a block diagram of a triggering unit in an embodiment of the invention; and

FIG. 5 is an embodiment of a protecting system according to the invention.

### DETAILED DESCRIPTION OF THE INVENTION

The invention provides a system for protecting a blade module of an informationprocessing apparatus when the module is not well connected on the informationprocessing apparatus.

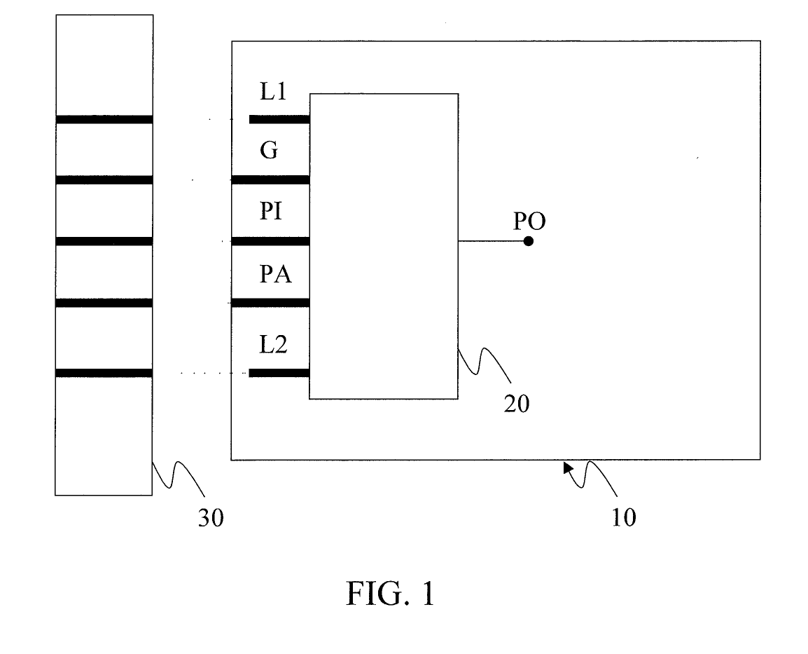

As shown in FIG. 1, a protecting system 20 is included in a blade module 10 of an information-processing apparatus. The blade module 10 is mounted through a connector 30 to the information-processing apparatus, such as a server. The blade module 10 includes at least a first interlock L1, a ground port G, a power-input port P1, an assistant power port PA and a second interlock L2. The second interlock L2 connects with the ground port G. The first interlock L1 connects with the second interlock L2 and forms a loop when the blade module 10 is well connected to the connector 30. The power input port P1 and the assistant power port PA bring in the working power and assistant power from the server through the connector 30.

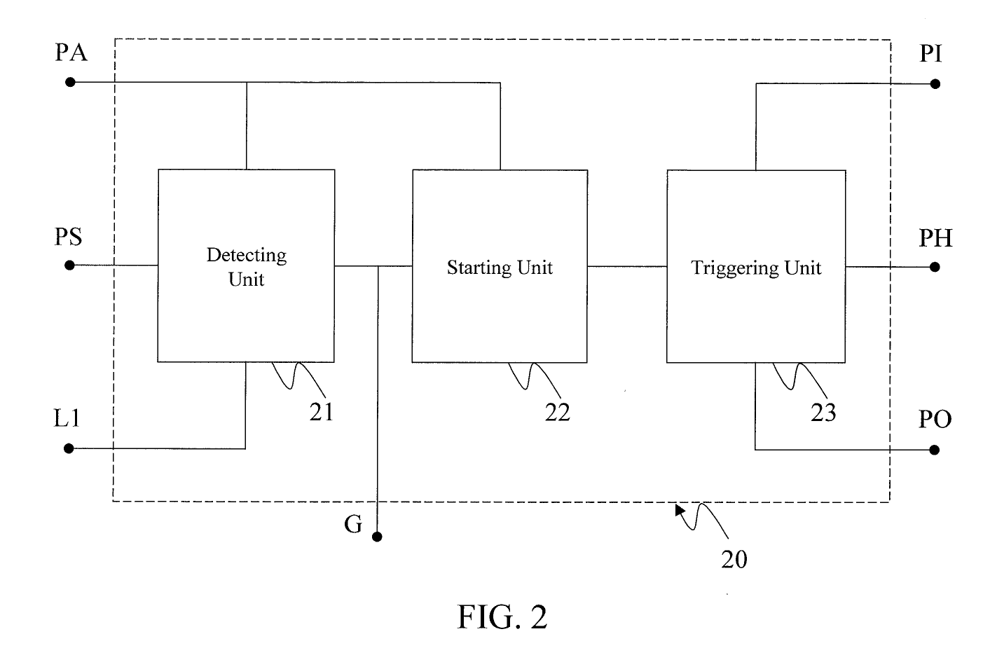

FIG. 2 shows a block diagram of a protecting system according to the invention. The protecting system includes a detecting unit 21, a starting unit 22 and a triggering unit 23. The detecting unit 21 connects with the first interlock L1 for detecting the condition of the connection between the first interlock L1 and the connector 30, and checks the preparative voltage PS when the first interlock L1 and the connector 30 are well connected. When the connection is good, the detecting unit 21 stops and provides the assistant power to the starting unit 22. The starting unit 22 receives the assistant power to conduct a hold voltage PH to the ground G. The triggering unit 23, connected to the starting unit 22, therefore conducts the working power coming from the power input port P1 to a power input port PO of the blade module 10 and starts its work.

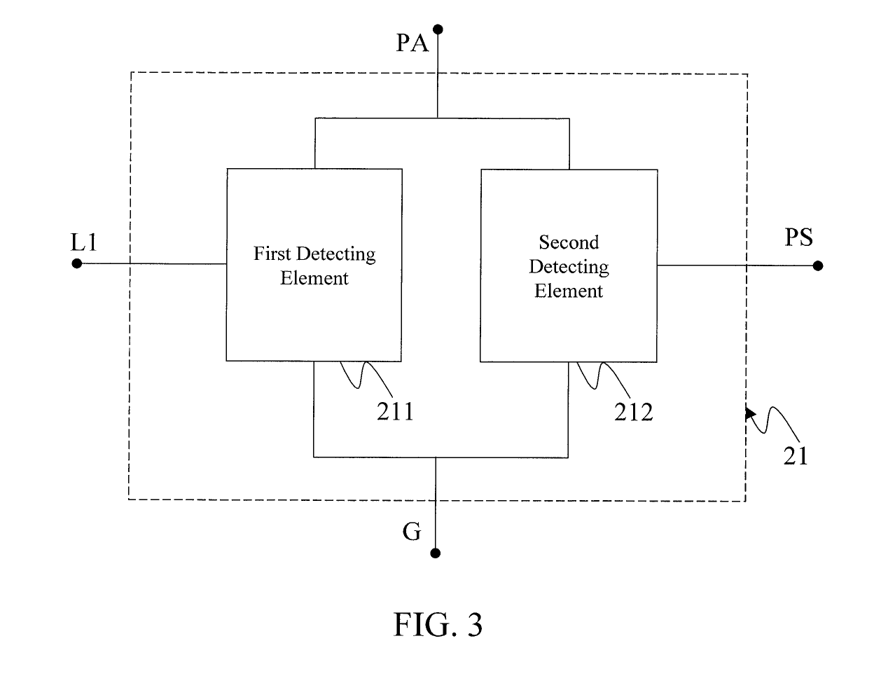

FIG. 3 is a block diagram of a detecting unit in an embodiment of the invention. The detecting unit 21 includes a first detecting element 211 and a second detecting element 212. The first detecting element 211 is a transistor connected with the first interlock L1 for detecting the connection status between the first interlock L1 and the connector 30. When they are well connected, the first detecting element 211 stops working. The second detecting element 212 is a transistor connected with the preparative voltage PS for detecting the preparative voltage. When the preparative voltage is correct, the second detecting element 212 stops working.

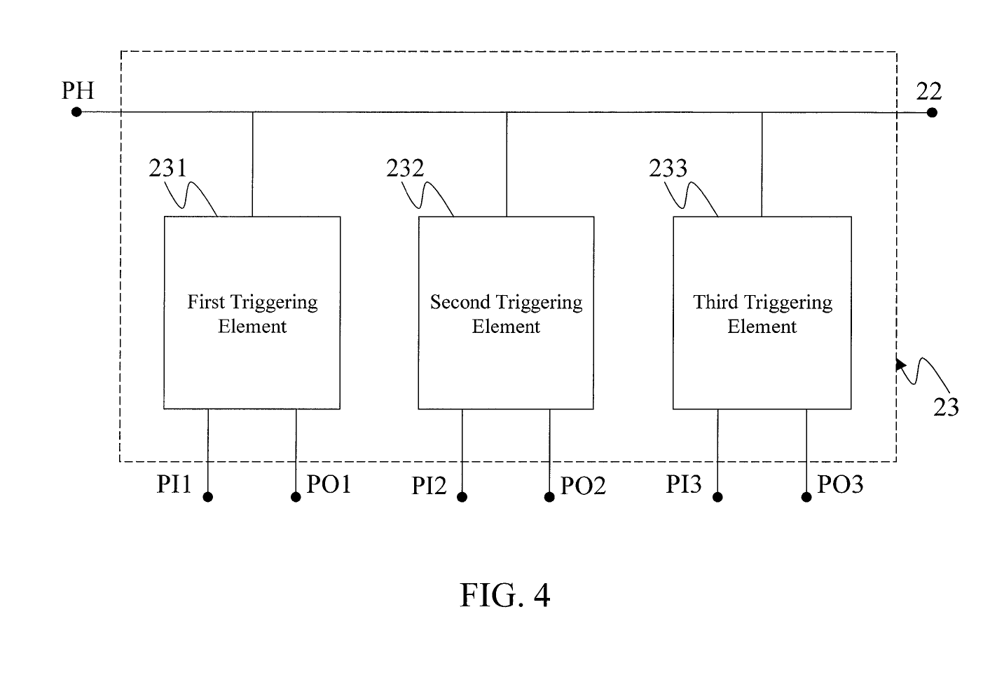

FIG. 4 is a block diagram of a triggering unit in an embodiment of the invention. The triggering unit 23 includes a first triggering element 231, a second triggering element 232 and a third triggering element 233. The first triggering element 231 can be a P-MOS (P-type metal oxide semiconductor). The input end of the first triggering element 231 connects with a first power input end PI1. The triggering end of the first triggering element 231 connects with the hold voltage PH. The output end of the first triggering element 231 connects with a first power output port PO1. When the hold voltage PH is conducted to the ground G, a first working power is provided to the first power output port PO1. The second triggering element 232 can also be a P-MOS. The input end of the second triggering element 232 connects with a second power input end PI2. The triggering end of the second triggering element 232 connects with the hold voltage PH. The output end of the second triggering element 232 connects with a second power output port PO2. When the hold voltage PH is conducted to the ground G, a second working power is provided to the second power output port PO2. The third triggering element 233 can also be a P-MOS. The input end of the third triggering element 233 connects with a third power-input end PI3. The triggering end of the third triggering element 232 connects with the hold voltage PH. The output end of the third triggering element 233 connects with a third power output port PO3. When the hold voltage PH is conducted to the ground G, a third working power is provided to the third power output port PO3.

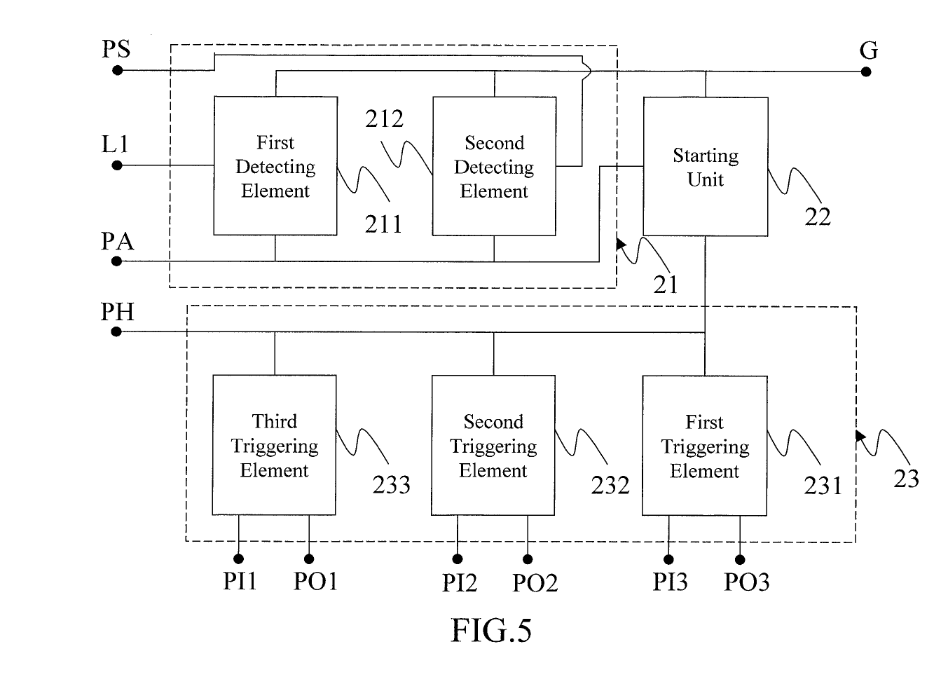

FIG. 5 shows an embodiment of a protecting system according to the invention. In the embodiment, there are three sets of working power, i.e. a first working power (e.g. 5 volt), a second working power (e.g. 12V) and a third working power (e.g. 3.3V) for supplying power to different parts of the blade module 10. When the blade module 10 connects to the connector 30, the first detecting element 211 checks whether the first interlock L1 is well connected to the connector 30. If it is well connected, the first detecting element 211 stops working. The second detecting element 212 connects to the preparative voltage PS and checks if the preparative voltage PS is correct. If it is okay, the second detecting element 212 stops working and transfers the assistant power PA to the starting unit 22. The starting unit 22 can be a transistor for conducting the hold voltage PH to the ground G when receiving the assistant power PA.

When the hold voltage PA is conducted to the ground G, the first triggering element 231, the second triggering element 232 and the third triggering element 233 are synchronously triggered so as to transfer the three sets of working power from the first, second and third power input ends PI1, PI2 and PI3 to the first, second and third power output ports PO, PO2 and PO3 respectively. Then the different voltage parts of the blade module 10 are put into work.

One of the advantages of the invention is that it triggers a plurality of power sets for the blade module so that no DC to DC voltage transformer is needed. Thissimplifies the circuit and saves cost. Furthermore, as shown in FIG. 1, the pins of the first interlock L1 and the second interlock L2 are shorter than normal pins so as to ensure the other pin connection between the blade module 10 and the connector 30. Therefore, any insufficient connection that will cause damage to the blade module or the information processing apparatus can be prevented. Another advantage is that the blade module of the invention is hot pluggable because no surge voltage is burst into the circuit while mounting the blade module.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system for protecting a blade module of an information processing apparatus from being damaged by unsuitable connection, comprising:
at least an interlock portion;
a detecting unit connected with said interlock portion for detecting the condition of connection between said interlock portion and said information processing apparatus checking a preparative voltage and stopping working and outputting an assistant power when said interlock portion and information processing apparatus are well connected;
a starting unit connected with said detecting unit for conducting a hold voltage to the ground when receiving said assistant power; and
a triggering unit connected with said starting unit for conducting at least a set of working power to said blade module when said hold voltage is conducted to said ground.

2. A system for protecting a blade module of an information processing apparatus according to claim 1 wherein said detecting unit comprises:
a first detecting element connected with said interlock portion for detecting the connection status between said interlock portion and the said information processing apparatus and stopping working when said interlock portion and information processing apparatus are well connected; and
a second detecting element connected with a preparative voltage for detecting the preparative voltage and stopping working when said interlock portion and information processing apparatus are well connected.

3. A system for protecting a blade module of an information-processing apparatus according to claim 2 wherein said first detecting element is a transistor.

4. A system for protecting a blade module of an information-processing apparatus according to claim 2 wherein said second detecting element is a transistor.

5. A system for protecting a blade module of an information-processing apparatus according to claim 1 wherein said starting unit is a transistor.

6. A system for protecting a blade module of an information processing apparatus according to claim 1 wherein said triggering unit further comprises:
a first triggering element having an input end connected with a first working power; a triggering end connected with said hold voltage; and an output end connected with a first power output port so as to provide said first working power to said first power output port when said hold voltage is conducted to the ground;
a second triggering element having an input end connected with a second working power; a triggering end connected with said hold voltage; and an output end connected with a second power output port so as to provide said second working power to said second power output port when said hold voltage is conducted to the ground; and
a third triggering element having an input end connected with a third working power; a triggering end connected with said hold voltage; and an output end connected with a third power output port so as to provide said third working power to said third power output port when said hold voltage is conducted to the ground;

7. A system for protecting a blade module of an information-processing apparatus according to claim 6 wherein said first triggering element is a P-type metal oxide semiconductor (P-MOS).

8. A system for protecting a blade module of an information-processing apparatus according to claim 6 wherein said second triggering element is a P-type metal oxide semiconductor (P-MOS) .

9. A system for protecting a blade module of an information-processing apparatus according to claim 6 wherein said third triggering element is a P-type metal oxide semiconductor (P-MOS) .

10. An system for protecting a blade module of an information-processing apparatus according to claim 1 wherein said information-processing apparatus is a server.
